(19) United States
(12) Patent Application Publication
(10) Pub. No.: US 2007/0187923 A1
(43) Pub. Date: Aug. 16, 2007

(54) Equalizer tandem pin puller

(76) Inventors: Leslie Doyle McNeal, Crossville, TN (US); Daniel Nicholas Gunter, Crossville, TN (US)

Correspondence Address: LESLIE DOYLE MCNEAL & DANIEL NICHOLAS GUNTER, 1857 COOK RD., CROSSVILLE, TN, 38555, US

(21) Appl. No.: 11/337,854

(22) Filed: Jan. 24, 2006

(51) Int. Cl. B62D 53/06

(52) U.S. Cl. 280/407.1

(57) ABSTRACT

The Equalizer Tandem Pin Puller is new and different because a driver will attach a steel 1¼″ length 1″ OD collar to the handle of the tandem pin handle, the collar is attached to a 24″ steel chain, then the driver will attach a steel clevis hook that is attach to a 6 inch steel chain, that is attached to a 24 inch steel pipe with a 45 degree curve in the upper end of it with a 4¼″ plastic grip on the bottom of the pipe and two 1¼″ grips on the Tee, keeping pressure on the chain, the driver while in a standing position, will then by holding the end of the steel handle place the 5½″ on the side of the trailer, about two inches up the side. Then he will pull upward on the handle, which pulls on the hook, which pulls on the collar that is attached to the handle of the tandem pin. This will release the pin, allowing the driver to adjust the tandems.

### REFERENCES CITED

### Cross-Reference to Related Applications

U.S. Pat. No. 6,354,642

Haggerty Mar. 12, 2002

3618969 November 1971 Glassmeyer

D289360 April 1987 Westcott

5065488 November 1991 Chapman et al.

5199731 April, 1993 Lands et al

5326144 July 1994 Forcier

5449190 September 1995 Ford

5564725 October 1996 Brazeal

5617072 April 1997 McNeal 280/441

5678834 October 1997 Wise

5833253 November 1998 Hess

6279932 August 2001 White et al 280/149

Foreign Patent Documents

566681 November 1958 C

584416 January 1947 GB.

A discussion of the related art of which the present inventor is aware, and its differences and distinctions from the present invention, is provided below.

U.S. Pat. No. 3,618,969 issued on Nov. 9, 1971 to John J. Glassmeyer, titled “Apparatus For Positioning Trailer Suspension Frame,” describes an automated mechanism for releasing the lock pin handle from its pulled position when the tandem axle unit has been repositioned to the desired location. The Glassmeyer mechanism goes beyond the scope of the present invention, in that it automatically releases the unlocking force on the lock pin handle to allow the lock pins to engage the desired corresponding holes in the trailer subframe. However, the Glassmeyer mechanism is a permanent installation and is integrated with the trailer; it cannot be removably applied to a trailer as a portable tool which is retained by the driver, as is the case with the present puller tool. While a driver who drives for a company whose trailers are equipped with the Glassmeyer mechanism would enjoy its benefits, the mechanism does nothing for drivers who have occasion to pull trailers not equipped with the Glassmeyer apparatus.

U.S. Pat. No. 5,065,488 issued on Nov. 19, 1991 to Richard L. Chapman et al., titled “Tandem Axle Trailer Pin Extracter Device,” describes a portable device generally comprising a tube with an internal spring and handlebars projecting therefrom. The spring provides a tensile force for hooks which project from opposed slots in the sides of the tube, with the handlebars being connected to the opposite end of the spring and projecting from the slots. The hooks are secured to the tandem lock pin release handle of the trailer, and the handlebars pulled and secured in retainer grooves at the opposite end of the slot, with the spring thus providing a tensile force on the lock pin release handle. The Chapman et al. device has no means of securing positively to the tandem axle slider frame, and thus requires a separate brace arm which bears against the ground while the tool is installed. In contrast, the present tool attaches securely to the tandem pin release handle. Also, the present tool (The Equalizer Tandem Pin Puller) is adjustable in length, to allow for different distances between the tandem slider frame and the outer edge of the trailer where the present tool may be manipulated.

U.S. Pat. No. 5,199,732 issued on Apr. 6, 1993 to Herbert D. Lands et al., titled “Apparatus For Unlocking A Bogie On A Tractor-Trailer Rig,” describes a permanently installed, pneumatically powered system for providing the required force for releasing the tandem locking pins. FIG. 2 of the Lands et al. disclosure illustrates an exemplary mechanism for retracting and extending the tandem unit locking pins, as is known in the art and which mechanism is operated by the tool of the present invention. While Lands et al. provide various other features, such as automatic pin extension in the event of the emergency brakes of the tandem unit being disengaged during operation, the mechanism is not portable in the sense that it cannot be quickly removed from the tandem unit by hand, without the use of tools, and carried by the driver in the cab of the truck. Also, Lands et al. do not address the problem of precisely locating the tandem unit as desired in its new position relative to the trailer.

U.S. Pat. No. 5,326,144 issued on Jul. 5, 1994 to Clarence D. Forcier, titled “Semitrailer Sliding Tandem Pin Puller,” describes a device similar to that of the '488 U.S. Patent to Chapman et al., discussed further above. The Forcier device comprises a tube with a coil spring installed concentrically therein, with a loop at the end of the spring for connecting to the locking pin release handle and a clamp at the end of the tube for securing the device to the edge of the trailer. Forcier also provides an optional flag or marker which extends past the end of the tube as the spring retracts when the lock pin handle is pulled for release. However, it is noted that the Forcier device secures to the trailer, rather than securing to the frame of the tandem wheel assembly. This will result in the device becoming overextended and possibly pull it loose from the trailer if the driver continues to move the trailer after the lock pins are pulled, as the spring attachment will remain with the lock pin handle while the opposite trailer attachment end moves with the trailer. Thus, a driver using the Forcier device would be required to leave the cab and remove the device once the pins are pulled to free the tandem axle unit. The driver would still be left to guess as to the position of the tandem unit for repositioning the unit, with multiple attempts perhaps being required to position the tandem unit as desired. The locator of the Equalizer Pin Puller does not have to provide an indication when the release handle is released, because he is standing right there looking at it, with Forcier's invention the driver has to get in and out of the truck.

U.S. Pat. No. 5,449,190 issued on Sep. 12, 1995 to William G. Ford, titled “Trailer Pin Puller,” describes a device which secures to the lock pin release handle and trailer side in much the same manner as the Forcier device discussed immediately above. However, the Ford device includes a threaded advance shaft connected to the outboard end of the spring (i.e., opposite its attachment end to the pin release handle), with which the tension on the spring may be adjusted. The Equalizer doesn't have a spring or a threaded advance shaft and the driver doesn't have to get in and out of the truck to move the pins.

U.S. Pat. No. 5,564,725 issued on Oct. 15, 1996 to Russell S. Brazeal, titled “Pneumatically Operated Slider Locking Mechanism,” describes a pneumatically powered assisting device for operating the otherwise conventional mechanism for retracting and extending the locking pins for a tandem axle unit. Pulling the release handle actuates the pneumatic system, which provides pneumatic pressure to retract the pins. The Brazeal pneumatic system thus teaches away from the present tool, as Brazeal does not require any form of external tensile pressure to pull the handle, due to the pneumatic assist. Also, the Brazeal system is. permanently installed on the trailer and relies upon the integral pneumatic system of the trailer, unlike the present portable tool.

U.S. Pat. No. D-289,360 issued on Apr. 21, 1987 to Orville H. Westcott, titled “Truck Tool,” illustrates a design comprising a flat bar with a hook at each end, and a narrow plate extending from one end and perpendicular to the plane of the bar. The Westcott Design Patent provides no indication of function for the device, and no means for applying tensile force to the lock pin release handle of a tandem axle unit. On the equalizer the hook is in the middle and one is a 1½″ round steel collar and the other end is a 5½″ steel Tee.

British Patent Publication No. 584,416 accepted on Jan. 14, 1947 to Ensor Caravans Ltd., titled “Improvements In Trailers And Like Road Vehicles,” describes a light trailer frame having a single longitudinally adjustable axle. The position of the axle is adjusted by a crank mechanism at one end of the trailer. The '416 British Patent Publication teaches away from the present tool, as no release handle is required with the mechanism of the British Patent Publication. The Equalizer pin puller is a quick on and quick off tool. Requiring very little work.

Finally, Canadian Patent Publication No. 566,681 issued on Nov. 25, 1958 to Charles B. Sheppard et al., titled “Pre-Selector For Positioning Running Gear Relative To Trailer Body Load,” describes a tandem axle adjustment mechanism which is permanently installed and integrated with the trailer assembly, unlike the present portable tool. Rather than providing a tool that is operated manually by the driver, Sheppard et al. provide a mechanism which automatically resets the lock pins according to prior adjustment when the tandem unit is repositioned to the predetermined location. Otherwise, the Sheppard et al. mechanism is more closely related to the permanently installed, integral mechanisms of the U.S. Patents to Lands et al., Brazeal, and Hess, than to the present portable puller tool for semi trailer tandem axle units.

None of the above inventions and patents, taken either singly or in combination, is seen to describe the instant invention as claimed.

### TECHNICAL FIELD

The Equalizer Tandems Pin Puller is a mechanical device that will help a Professional Over The Road Semi-Truck driver to release the tandem pins on a semi trailer.

The present tool comprises of two pieces:

1. a steel 1 inch ¾ diameter collar (FIG. 1), a 24 inch chain (FIG. 2),

2. a clevis hook (FIG. 3) connected to a six inch chain (FIG. 4), which is connected to a 24 inch curved steel pipe (FIG. 6), which is connected to a 5½ crossbar (FIG. 5), 4¼″ grip and two 1¼″ grips (FIG. 8 and FIG. 9)

Still another object of the invention is to provide an improved tool which is portable and easily carried by a truck driver.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

In making “The Equalizer Tandem Pin Puller”:

First cut one piece of ¾″ structural pipe 24″ long (FIG. 5), then cut one piece ¾″ structural pipe 5½″ long (FIG. 6) and also cut one piece 1″ structural pipe 1¼″ long (FIG. 1).

You will need two pieces of 3/16″ chain, one 24″ (FIG. 2) and one 6″ (FIG. 2).

Take the ¾″ by 24″ pipe (FIG. 5) and put a 45 degree bend 2½″ from one end. Then weld the ¾″ by 5½″ pipe (FIG. 6) across the end of the ¾″ by 24″ pipe (FIG. 5) near the end that has the 45 degree bend in it. Thus making a crossbar. Then take the 6″ by 3/16″ chain (FIG. 4) and weld it 8½″ from the crossbar on the inside of the 45 degree bend (FIG. 5). Also attach a ¼″ clevis grab hook (FIG. 3) on the end of the 3/16″ by 6″ chain (FIG. 4) welded to the pipe (FIG. 5) part of the puller.

Attach the grips (FIG. 7 and FIG. 8) to the crossbar and the 24 inch handle This will complete the lever part of the puller. Next weld the 1″ by 1¼″ pipe (FIG. 1) to one end of the 24″ by 3/16″ chain (FIG. 2) this will make the collar that slides over the handle that will pull the tandem pins out of the tandem. Then slide the 4¼″ grip (FIG. 8) over the Lever (FIG. 5). Slide the 1¼″ grips (FIG. 7) over the crossbar (FIG. 6) on the right and left ends.

In Using “The Equalizer Tandem Pin Puller”

Start by taking FIG. 1 (1 inch steel collar) and placing it over the handle of the tandems pins. Take FIG. 2 ( 24 inch steel chain) and hold it tight and attach FIG. 3 (Steel Clevis hook) to FIG. 2. FIG. 4 is attach to the Clevis Hook (FIG. 3) and the 24 inch with the 45 degree angle bend, ¾ pipe (FIG. 5) Hold FIG. 5 firmly and place FIG. 6 against side of trailer, about two inches up on side of trailer. Pull up with FIG. 5. This will pull the chains that is attached to the tandem pin handle, Therefore releasing the tandem pin and allowing the tandems to be moved or slid into the correct position. If the first pull doesn't release the pins, let the pressure off and re-hook the clevis hook, shorten the chain and pull again. Until the pins do release.

### BRIEF DESCRIPTION OF DRAWINGS

FIG. 1. 1″ steel collar

FIG. 2. 24″ steel chain

FIG. 3. steel clevis grab hook

FIG. 4. 6″ steel chain

FIG. 5. curved ¾ steel pipe with a 45 degree curve

FIG. 6. 5½″ crossbar

FIG. 7. 1¼″ grips

FIG. 8. 4¼″ grips

### DETAILED DESCRIPTION OF THE INVENTION

This invention is new and different by the design of The Equalizer Pin Puller. This is a two piece tool when all 8 pieces are assembled. The eight (8) different pieces are, A 1½″ steel collar, a 24″ curved steel pipe, a 5½″ steel crossbar, a 6″ chain, a steel clevis hook, One (1) 4¼″ grip and two 1¼″ grips. The Equalizer Tandem Pin Puller engages to the side of the trailer to help the driver loosen the pins. It does exactly what it is called, it equalizes the pressure on the Tandem pins allowing them to line up without having to have any assistance by another person or using physical force. It allows the driver to see what they are doing right at the tandems. It keeps them safe and other drivers that would otherwise be needed to help pull the pins. It helps prevent shoulder injuries by using the side of the trailer to help pull the tandem pins. By the drivers being able to stay on the ground instead of having to get in and out of the truck to loosen the tandems pin

I (We) claim:

1. A pulling tool for maintaining a pulling force on the handle of a manual tandem pin of a semi truck trailer, said pulling tool comprising of:
means for engaging the handle with a 45 degree curve of the manual tandem pin puller,
means for imposing a tensile force on the handle of the manual pin puller, wherein said tensile force bears on said means for engaging the handle of the manual pin puller,
a chain for maintaining said tensile force on the handle of the manual pin puller, said chain bearing on said means for engaging the handle of the manual pin puller, and a crossbar for pivotally attaching the pulling tool to the vehicle trailer.

2. The pulling tool according to claim 1, said means for engaging the handle of the manual pin puller comprising two pieces, 1) a hook, a handle, a 6 inch chain, 2) a 24 inch chain, a ¼ inch long collar.

3. The pulling tool according to claim 1, said means for imposing said tensile force on the handle of the manual pin puller comprising a crossbar operable connected to said means for engaging the handle of the manual pin puller.

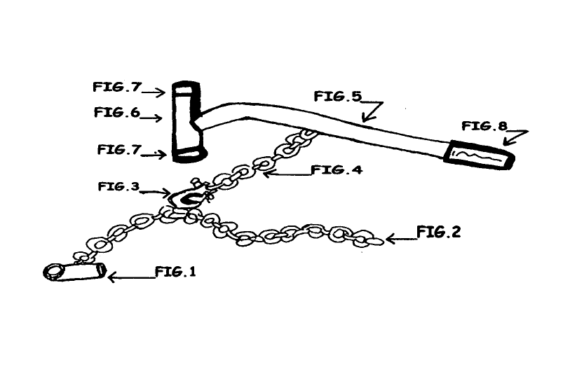

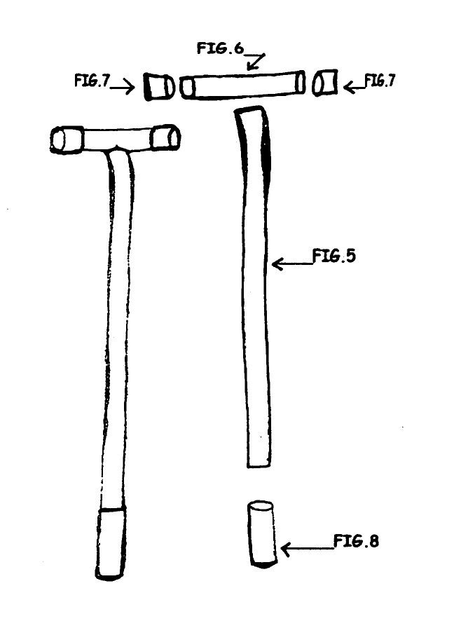

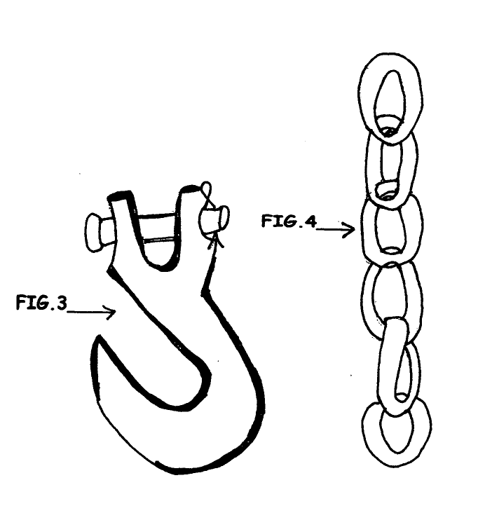

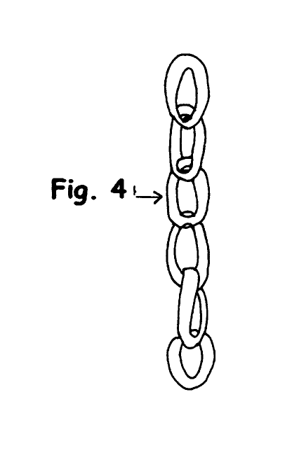

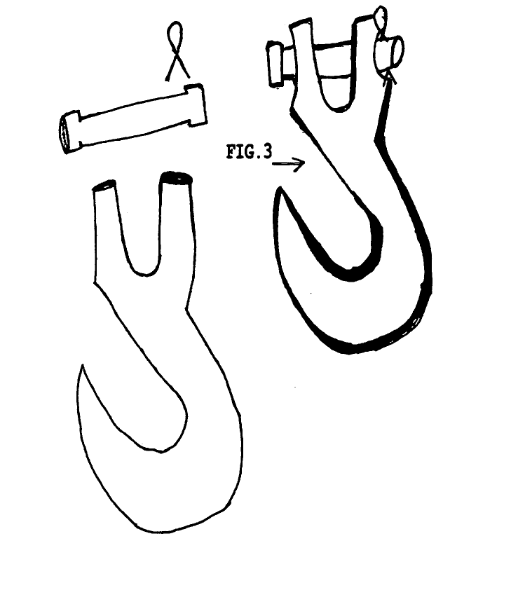

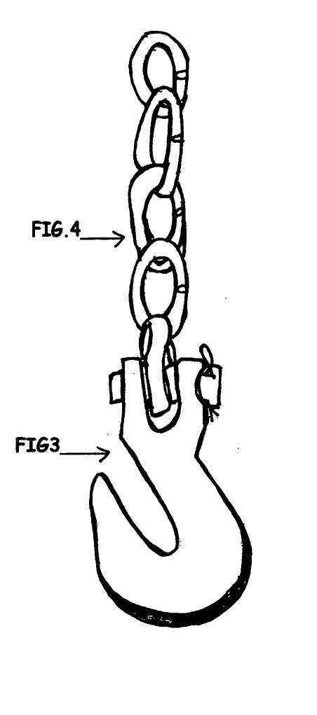

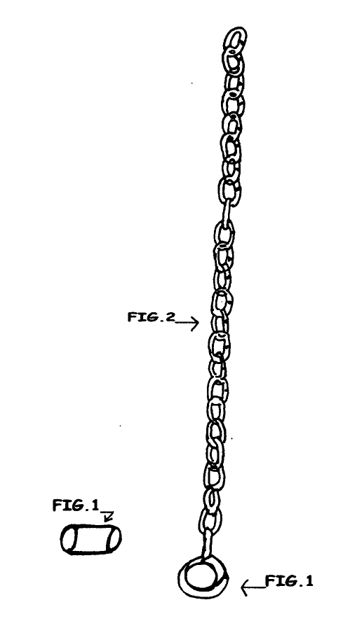

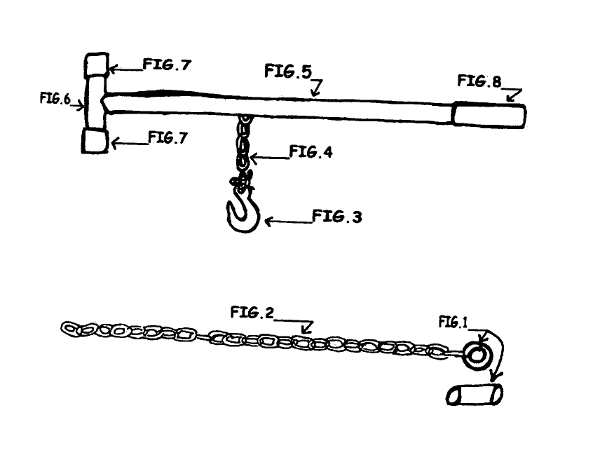

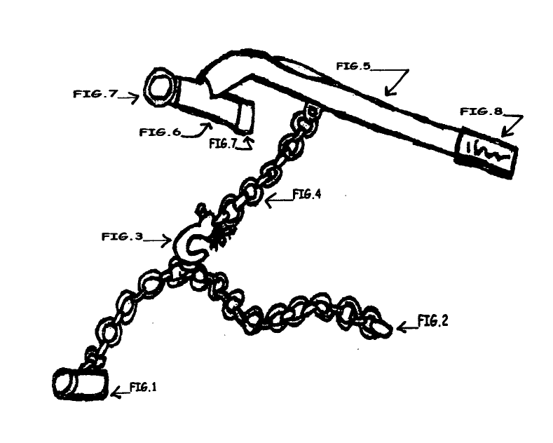

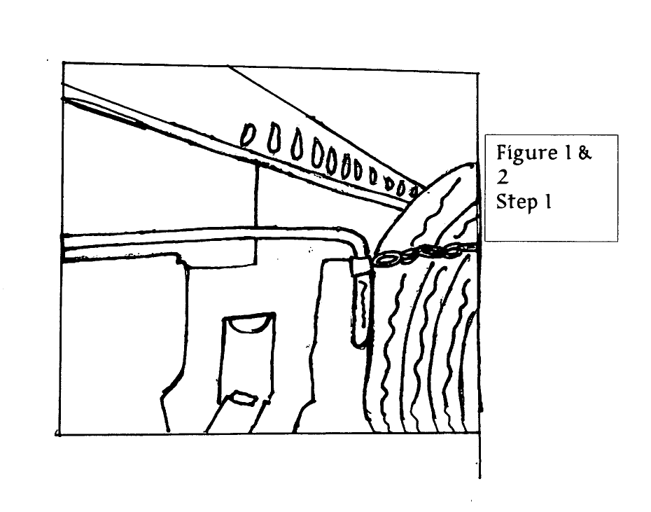

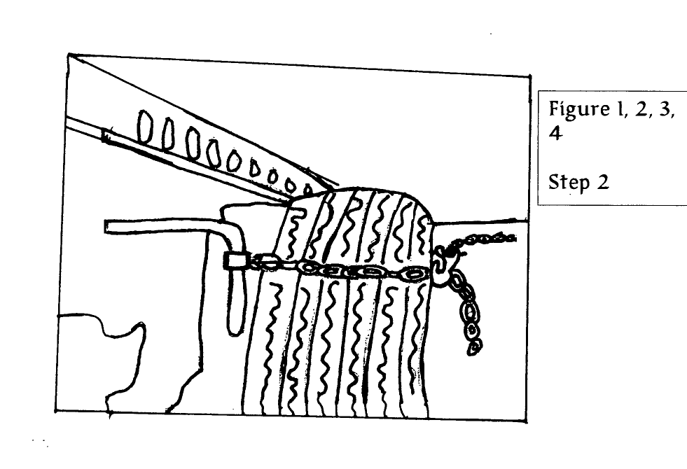

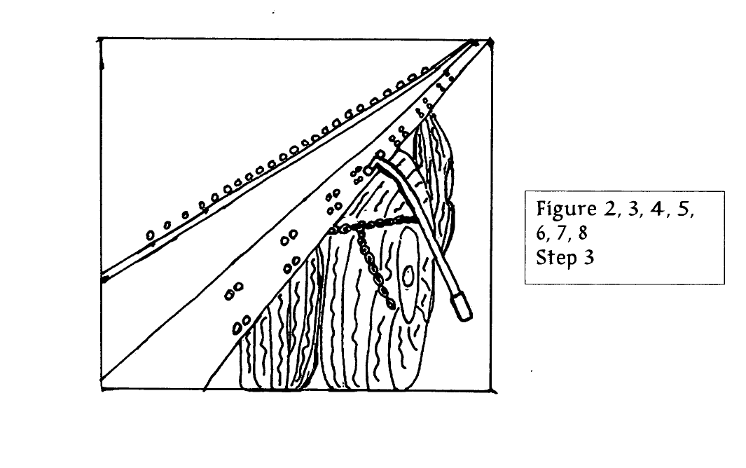

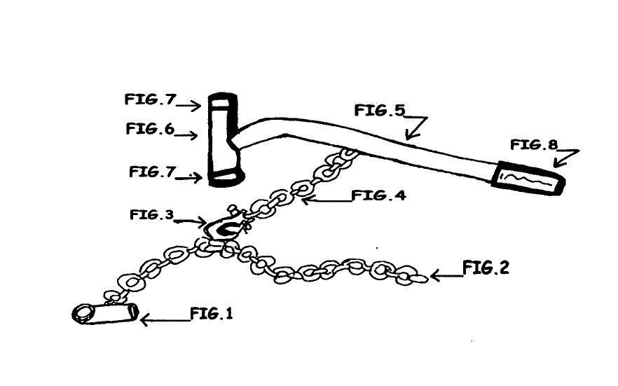

4. I claim the process of making the Equalizer Tandem Pin Puller. The 45 degree bend in the handle of the tandem pin puller (FIG. 5), the crossbar of the tandem pin puller (FIG. 6), the chain welded to the handle (FIG. 4), the hook connected to the chain (FIG. 3), the chain that works with the hook, chain and handle (FIG. 2). The collar connected to the chain (FIG. 1).

5. I claim the steel bar, with the 45 degree angle bend, two inches from the top of the steel pipe. for the making of the manual tandem pin puller
